(19) United States
(12) Patent Application Publication
(10) Pub. No.: US 2010/0326246 A1
(43) Pub. Date: Dec. 30, 2010

(54) WRENCH WITH SWITCHABLE RATCHET WHEEL SETS

(76) Inventor: Chin-Chia Chang, Taichung County (TW)

Correspondence Address: Muncy, Geissler, Olds & Lowe, PLLC, 4000 Legato Road, Suite 310, FAIRFAX, VA, 22033, US

(21) Appl. No.: 12/821,848

(22) Filed: Jun. 23, 2010

(30) Foreign Application Priority Data
Jun. 25, 2009 (TW) 98211444

(51) Int. Cl. B25B 13/46

(52) U.S. Cl. 81/60

(57) ABSTRACT

A wrench with switchable ratchet wheel sets includes a graspable body with at least one end having a support jaw set, in which support jaw set a rotatable tool seat is provided and pivotally connected to the support jaw set by a pivot is provided with at least two ratchet wheel sets; and a switch assembly settled on the graspable body near the support jaw set and having a switch that has a shaft passing through the graspable body, and that the shaft has two ends extending as two holding ends and thus enabling the switch to make the rotatable tool seat laterally retained by the two holding ends.

### BACKGROUND OF THE INVENTION

1. Technical Field

The present invention relates to wrenches, and more particularly, to a wrench having plural ratchet wheel sets of different sizes wherein the plural ratchet wheel sets are switchable for versatile operation.

2. Description of Related Art

Hexagonal nuts or bolts are fastening parts commonly used in house appliances, transportation and industrial machines and can be screwed or unscrewed by using open-end wrenches, ratchet wrenches, close-end wrenches and socket wrenches. Such nuts and bolts are made into a series of various sizes for meeting different fastening needs. Furthermore, nuts and bolts of many different sizes can exist in the same machine so it is necessary for people who maintain this machine to prepare and carry plural wrenches each of different size. The batch of wrenches not only requires considerable costs but also brings difficulty in store and management.

### SUMMARY OF THE INVENTION

In view of the foregoing shortcomings of the existing wrenches, the present invention provides a wrench with switchable ratchet wheel sets, which comprises: a graspable body having at least one of its ends provided with a support jaw set that supports a rotatable tool seat, wherein the rotatable tool seat has a middle portion pivotally connected to the support jaw set by a pivot and is provided with at least two said ratchet wheel sets; each ratchet wheel set including a ratchet positioning hole passing therethrough, the ratchet positioning hole receiving a ratchet wheel, the ratchet wheel being centrally past by a part receiving hole and peripherally provided with ratchet teeth, a recess being formed at a side of the ratchet positioning hole and pivotally receiving a ratchet pawl therein, a spring being positioned between the ratchet pawl and the recess so that the ratchet pawl removably engages the ratchet teeth of the ratchet wheel, and a ratchet wheel cover covering openings of the ratchet positioning hole and the recess; and a switch assembly being provided on the graspable body near the support jaw set, the switch assembly including a switch, the switch having a shaft passing through the graspable body, the shaft has two end extending to form two holding ends, and the switch is operatable to make the two holding ends sandwich and thereby position the rotatable tool seat.

The wrench with switchable ratchet wheel sets according to the present invention has the advantages described below.

First, the wrench has the ratchet wheel sets of different sizes provided on the rotatable tool seat and the ratchet wheel sets are switchable by rotating the rotatable tool seat. Operation of switching the ratchet wheel sets is simple and convenient. Meantime, the switch can firmly hold the rotatable tool seat to prevent the rotatable tool seat from rotation in the course of screwing or unscrewing an external part with the wrench, thereby ensuing safe use.

Second, the support jaw set has two jaws and the two jaws have attached reinforcing plates, which further enhance the durability and operation strength of the disclosed wrench, so as to improve capability of the jaws and prevent the jaws from breaking in operation.

### BRIEF DESCRIPTION OF THE DRAWINGS

The invention as well as a preferred mode of use, further objectives and advantages thereof will be best understood by reference to the following detailed description of an illustrative embodiment when acquire in conjunction with the accompanying drawings, wherein:

FIG. 1 is a perspective view of the present invention;

FIG. 2 is an exploded view of the present invention;

FIG. 3 is a schematic sectional view of the present invention;

FIGS. 4 and 5 are perspective views illustrating operation of the present invention; and

FIGS. 6 and 7 are top views illustrating operation of the present invention.

### DETAILED DESCRIPTION OF THE INVENTION

While a preferred embodiment provided hereinafter for illustrating the concept of the present invention as described above, it is to be understood that the components of the embodiment shown in the accompanying drawings are depicted for the sake of easy explanation and need not to be made to exact scale.

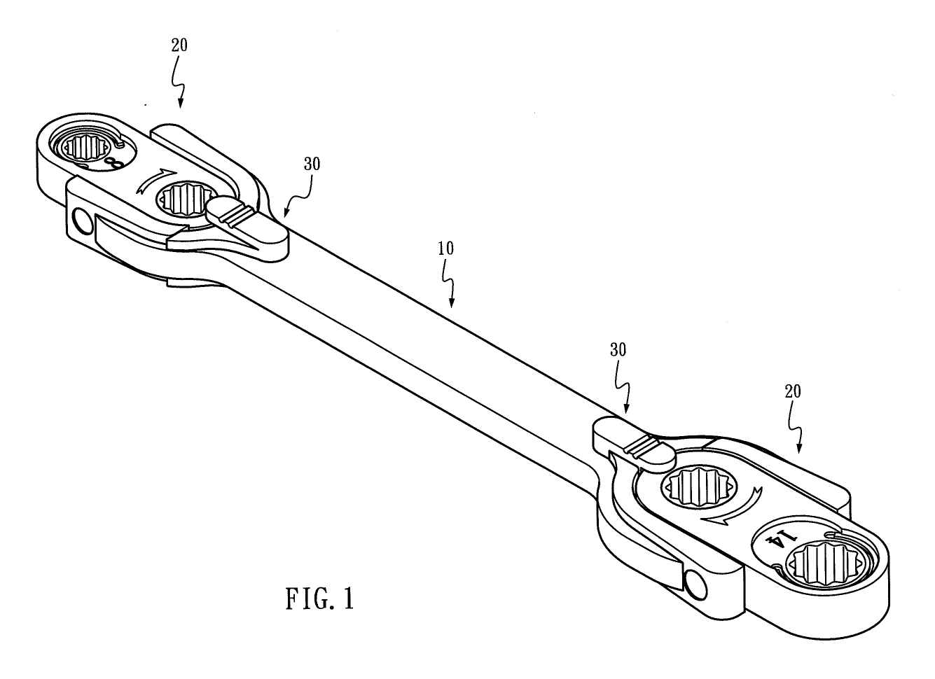

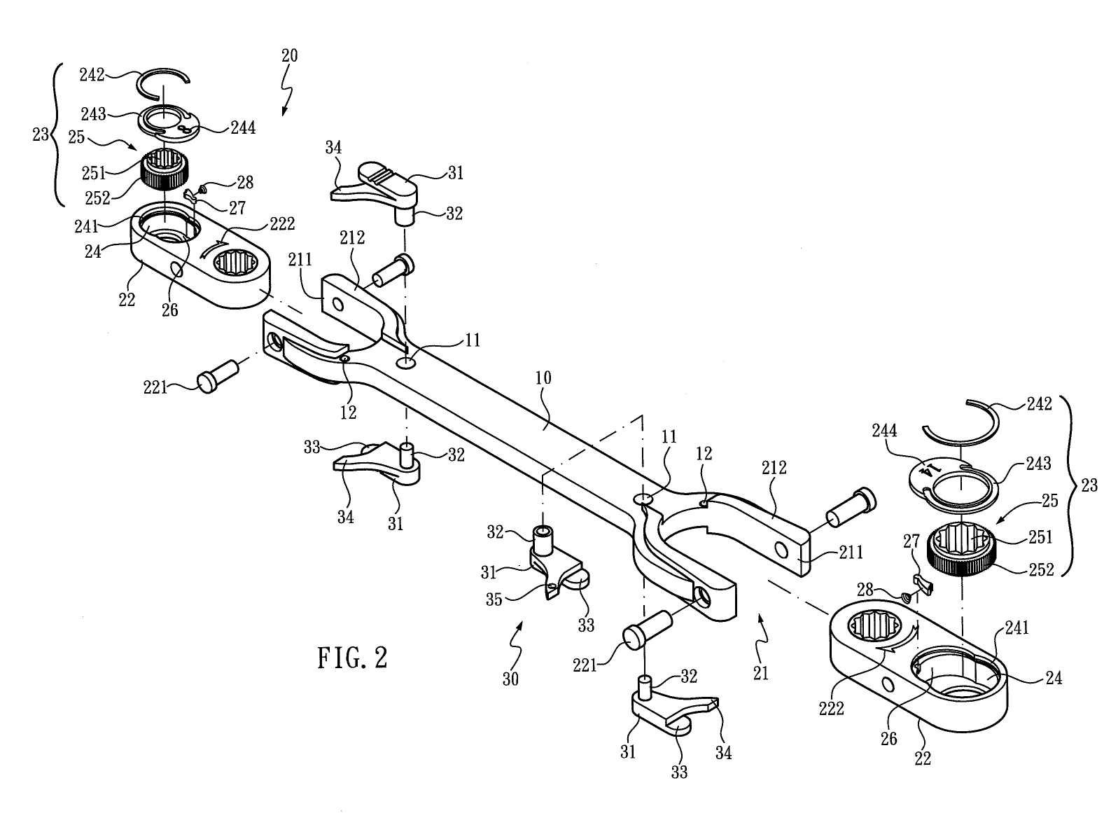

Referring to FIG. 1 and FIG. 2, a wrench with switchable ratchet wheel sets of the present invention comprises a graspable body 10 whose at least one end is provided with a switchable tool assembly 20.

The switchable tool assembly 20 includes a support jaw set 21 attached to the end of the graspable body 10. The support jaw set 21 serves to support a rotatable tool seat 22 therein. The rotatable tool seat 22 at its middle portion is pivotally connected to the support jaw set 21 by means of a pivot 221 so as to allow the rotatable tool seat 22 to rotate against the pivot 221. The rotatable tool seat 22 is equipped with at least two ratchet wheel sets 23. The support jaw set 21 is composed of two jaws 211, and each of the jaws 211 has an attached reinforcing plate 212.

Therein, each said ratchet wheel set 23 comprises a ratchet positioning hole 24 passing through the rotatable tool seat 22. The ratchet positioning hole 24 receives a ratchet wheel 25. The ratchet wheel 25 is centrally past by a part receiving hole 251 and has ratchet teeth 252 circularly provided its inner periphery. A recess 26 is formed at a side of the ratchet positioning hole 24 and pivotally receives a ratchet pawl 27 therein. The ratchet pawl 27 has one end pivotally connected to a wall of the recess 26, while a spring 28 is settled between the ratchet pawl 27 and the recess 26 so that the ratchet pawl 27 is movably engage with the ratchet wheel 25. Therein, a groove 241 is formed on a wall of the ratchet positioning hole 24 near the opening of the latter for fittingly receiving a C-shaped retaining ring 242 to further position a ratchet wheel cover 243. The two ratchet wheel sets 23 on the rotatable tool seat 22 are of different sizes for operating parts of corresponding sizes. In addition, the two ratchet wheel sets 23 have their working faces facing two opposite surfaces of the rotatable tool seat 22 and have the ratchet wheel covers 243 marked with respective size indication codes 244 for indicating the part size operatable to the part receiving holes 251. Moreover, a directional indication mark 222 is formed on the rotatable tool seat 22 for each said ratchet wheel set 23, for a user to easy recognize the operational direction of each said ratchet wheel 25.

Additionally, a switch assembly 30 is provided on the graspable body 10 near the support jaw set 21. The switch assembly 30 comprises a switch 31 that has a shaft 32, while there is a shaft hole 11 passing through the graspable body 10 near the support jaw set 21 so that the shaft 32 of the switch 31 can be rotatably received in the shaft hole 11. The shaft 32 has two ends extending as two holding ends 33. The switch 30 is operatable to make the rotatable tool seat 22 laterally retained by the two holding end 33. Therein, the switch 30 has an extending arm 34 formed with a positioning hole 35 facing the graspable body 10, and the graspable body 10 is equipped with a resilient positioning ball 12, so that when the positioning ball 12 is engaged in the positioning hole 35, the switch 30 is positioned.

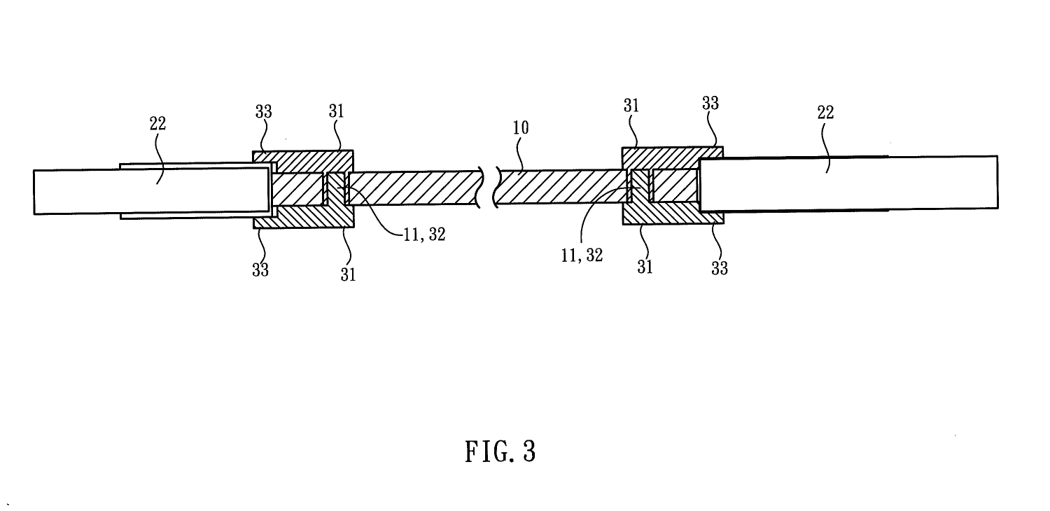

Referring to FIG. 1 and FIG. 3, in operation of the disclosed wrench, the switch 30 is such positioned that the two holding ends 33 of the switch 30 retain the rotatable tool seat 22 so as to prevent the rotatable tool seat 22 from rotation. Then the ratchet wheel set 23 jutting out of the support jaw set 21 can be used to screw or unscrew an external nut or bolt by rotating along the direction indicated by the directional indication mark 222. In operation, the switch 30 is well positioned by the engagement between the positioning hole 35 of the extending arm 34 and the positioning ball 12, so as to prevent the switch 30 being accidentally moved in the course of screwing or unscrewing the nut or bolt.

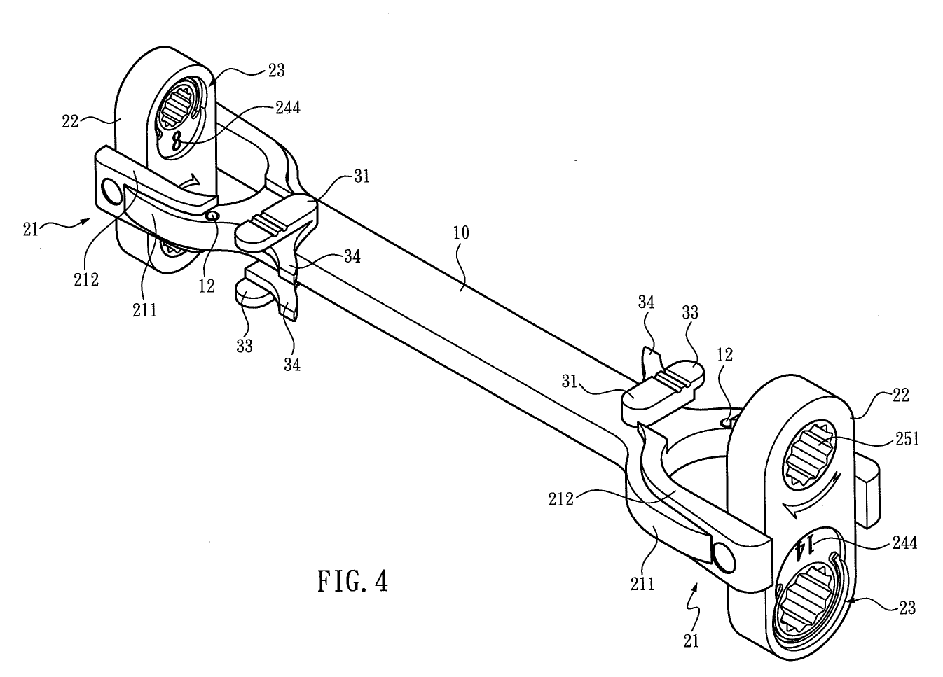

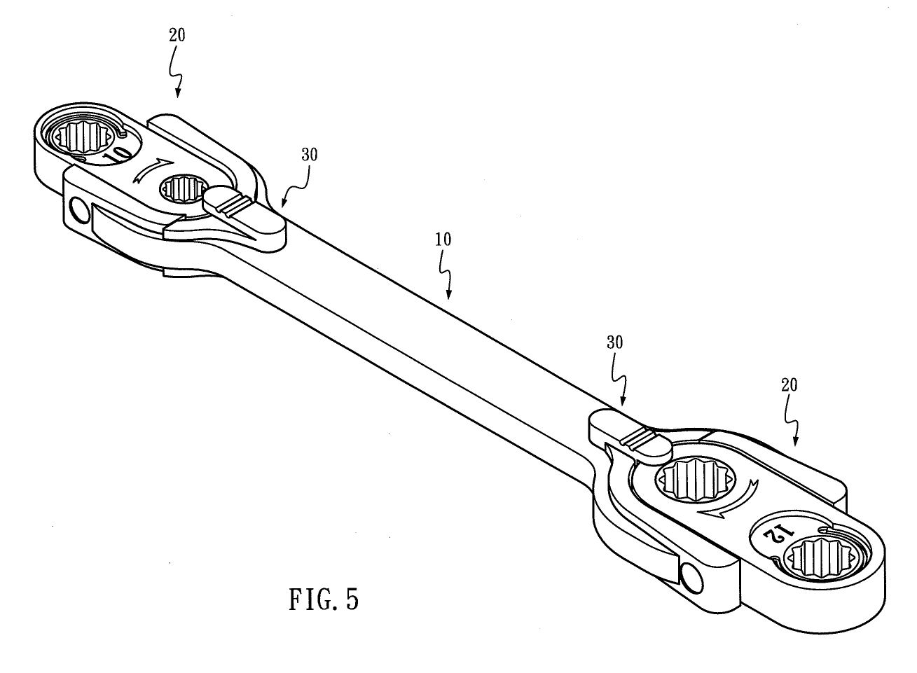

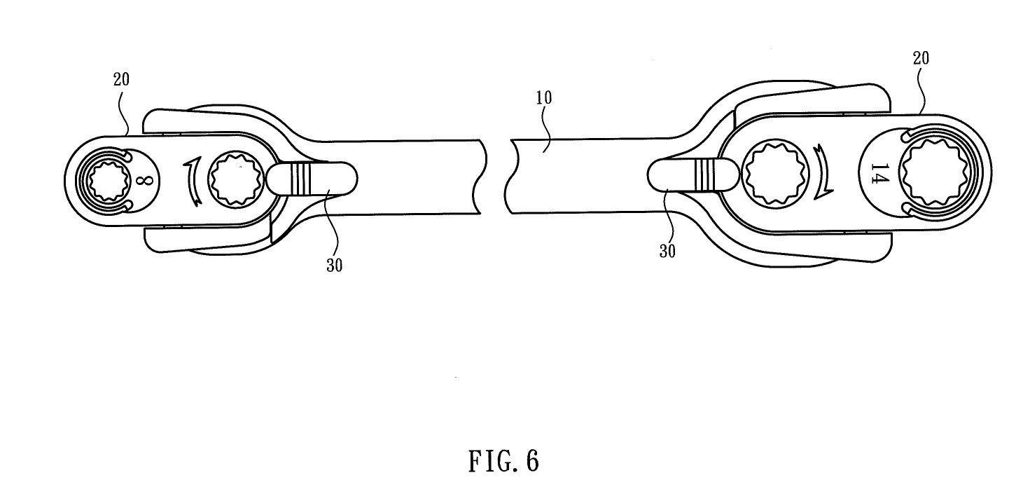

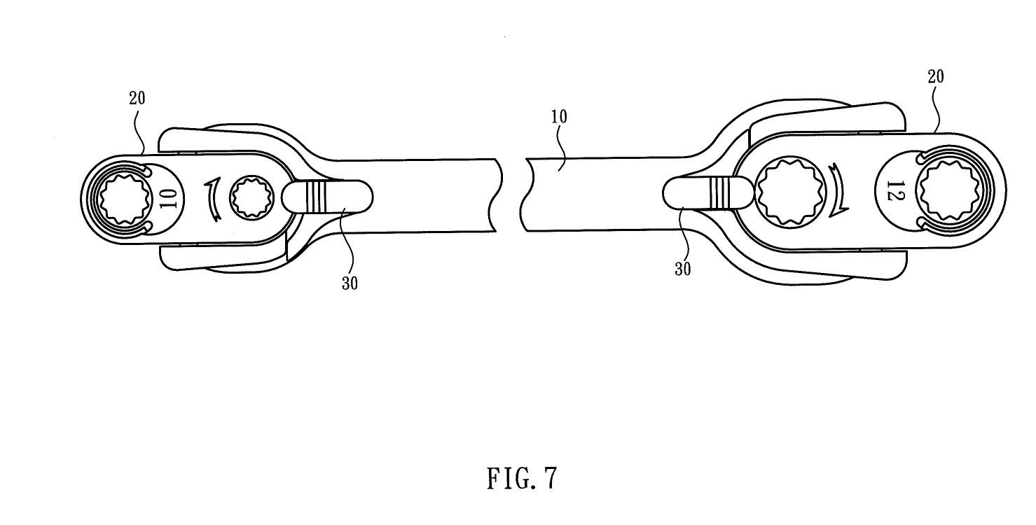

As shown in FIG. 4 and FIG. 5, when an alternative ratchet wheel set 23 of the different size is desired to be used, the switch 30 can be operated by applying an sufficient force that disengages the positioning ball 12 from the positioning hole 35 of the extending arm 34, and then the holding end 33 can be rotated toward the lateral of the graspable body. By doing so, the two holding ends 33 are removed from the rotatable tool seat 22, and thus the ratchet wheel sets 23 can be switched in position by rotating the rotatable tool seat 22. Afterward, the switch 30 is returned to the initial position where the two holding ends 33 sandwich the rotatable tool seat 22 again, thereby accomplishing a switch act between the ratchet wheel sets 23.

In the embodiment of the invention shown in the drawings, the disclosed wrench has each end of the graspable body 10 provide with a said switchable tool assembly 20, and the rotatable tool seat 22 of each said switchable tool assembly 20 has two ratchet wheel sets 23. Thus, one such graspable body 10 can carry four ratchet wheel sets 23 of different sizes, thereby significantly improving the versatility of the wrench.

Meantime, in virtue of the switch assembly 30, switching ratchet wheel sets 23 is simplified and the rotatable tool seat 22 is secured from moving during operation.

In addition, the reinforcing plates 212 attached to the jaws 211 of the support jaw set 21 can further enhance the durability and operation strength of the disclosed wrench, so as to improve capability of the jaws 211 and prevent the jaws 211 from breaking in operation.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention rather than limit the scope of the present invention. Accordingly, the foregoing description and drawings are by way of example only.

What is claimed is:

1. A wrench with switchable ratchet wheel sets, comprising:
a graspable body having at least one of ends thereof provided with a support jaw set that supports a rotatable tool seat, wherein the rotatable tool seat has a middle portion pivotally connected to the support jaw set by a pivot and is provided with at least two said ratchet wheel sets;
each ratchet wheel set including a ratchet positioning hole passing therethrough, the ratchet positioning hole receiving a ratchet wheel, the ratchet wheel being centrally past by a part receiving hole and peripherally provided with ratchet teeth, a recess being formed at a side of the ratchet positioning hole and pivotally receiving a ratchet pawl therein, a spring being positioned between the ratchet pawl and the recess so that the ratchet pawl removably engages the ratchet teeth of the ratchet wheel, and a ratchet wheel cover covering openings of the ratchet positioning hole and the recess; and
a switch assembly being provided on the graspable body near the support jaw set, the switch assembly including a switch, the switch having a shaft passing through the graspable body, the shaft has two ends extending to form two holding ends, and the switch is operatable to make the two holding ends sandwich and thereby position the rotatable tool seat.

2. The wrench of claim 1, wherein the ratchet wheel sets on the rotatable tool seat are of different sizes.

3. The wrench of claim 2, wherein the two ratchet wheel sets have working faces thereof facing two opposite surfaces of the rotatable tool seat, respectively.

4. The wrench of claim 1, wherein the support jaw set is formed by two jaws and each said jaw has an attached reinforcing plate.

5. The wrench of claim 1, wherein a groove is formed on a wall of the ratchet positioning hole near the opening of the ratchet positioning hole for fittingly receiving a C-shaped retaining ring so as to position the ratchet wheel cover.

6. The wrench of claim 1, wherein the graspable body is formed with a shaft hole passing therethrough for receiving the shaft of the switch.

7. The wrench of claim 1, wherein the switch has an extending arm, which is formed with a positioning hole facing the graspable body, and the graspable body is equipped with a resilient positioning ball, so that when the positioning ball is engaged in the positioning hole, the switch is positioned with respect to the graspable body.

8. The wrench of claim 1, wherein each said ratchet wheel cover is marked with a respective size indication code for indicating a part size operatable to the part receiving hole.

9. The wrench of claim 1, wherein a directional indication mark is formed on the rotatable tool seat for each said ratchet wheel set to indicate an operational direction of the ratchet wheel.
